(19) United States
(12) Patent Application Publication
(10) Pub. No.: US 2012/0173639 A1
(43) Pub. Date: Jul. 5, 2012

(54) METHOD AND SYSTEM FOR PERSONALIZED MESSAGE DELIVERY

(76) Inventors: Thomas Walsh, Tecumseh, MI (US); Steven J. Catani, Athens, GA (US); Maurice Collins, Chelsea, MI (US); Lauren M. Didyk, Plymouth, MI (US); Helene Gidley, Ann Arbor, MI (US); David A. Gregorka, Ann Arbor, MI (US); John Hetrick, Ann Arbor, MI (US); Jeffrey Matthes, Ypsilanti, MI (US); Thomas E. Sox, Ambler, PA (US); Victor J. Strecher, Ann Arbor, MI (US)

(21) Appl. No.: 13/283,039

(22) Filed: Oct. 27, 2011

Related U.S. Application Data
(60) Provisional application No. 61/429,228, filed on Jan. 3, 2011.

(51) Int. Cl. G06F 15/16

(52) U.S. Cl. 709/206

(57) ABSTRACT

A method and system for providing personalized message delivery to a user is disclosed. In accordance with the method and system, data specific to a user is gathered, analyzed and used to determine preferences and order of precedence of the user; and personalized message delivery is provided based upon the user's preferences and order of precedence.

### CROSS-REFERENCE TO RELATED APPLICATIONS

This application claims priority from U.S. Provisional Applications Ser. No. 61/429,228 filed Jan. 3, 2011, the contents of each of which are hereby incorporated by reference in their entirety.

### FIELD OF THE INVENTION

The present invention relates to a method and system for providing personalized message delivery to a user. The method and system are particularly useful in preventative care.

### BACKGROUND OF THE INVENTION

The health care community has recognized the importance of preventive care in managing patients' health. Preventive care is important for managing the health of patients having chronic diseases or long-term conditions, as well as for reducing the incidence of undesirable behavior (e.g., smoking) in at-risk patients. Preventive care includes educating patients about diseases and/or health consequences of behavior and providing patients with tools and/or treatments for managing diseases or behaviors.

Commonly used preventive care approaches suffer from several drawbacks. Much of preventive care is voluntary, and thus a large fraction of preventive care resources is typically spent on patients who actively seek involvement in their care. A large number of patients do not actively seek information and treatment. There is thus a need to take remedial steps before a disease or condition affects a patient symptomatically. Reaching passive patients and people at risk for developing medical conditions is critical to delivering effective preventive care.

The techniques for health education used by most health maintenance organizations (HMOs) and insurance companies allow little customization of information to an individual patient's needs. Consequently, many patients may not directly identify with the approaches. Personalizing health education would significantly raise the effectiveness of preventive health care.

U.S. Pat. No. 6,375,469 to Health Hero Network, Inc. discloses a system for delivering health information to a patient without requiring specific patient requests for the information that involves delivering the information to the patient during the course of normal recreational activities. This method does not provide a method or system capable of delivering a personalized message to a user at the desired time.

Different methods and/or systems are known for the delivery of information to individuals. For example, U.S. Pat. No. 7,949,712 to AT&T Intellectual Property L.L.P., discloses a method for deploying a high availability presence engine for instant messaging that includes: receiving a user's presence change information in a global table; updating the global table to reflect the change in the user's presence information; and sending updated presence information on the user to local tables of contacts affected by the change in the user's presence; and U.S. Pat. Nos. 7,756,744 and 7,895,078 to Dotomi Inc. disclose a method for messaging over a data network, comprising: i) providing an Administration Server (AS) in which user portfolios are stored, said AS being in communication with a terminal belonging to a user; ii) allowing every registered user to generate and update one or more user portfolio(s) containing information relative to Providers and/or individuals the messages of which the user is willing to view; and iii) displaying to one or more users on their terminal messages according to the information contained in the user portfolio. While many of these methods and/or systems provide information to the user, they lack the intuitiveness to decide when the message will be most effective, based on learned patterns, user feedback, lack of user feedback and user preferences as well as what the content of the message should be. As a consequence, there is a need for a method and system of determining and implementing user preferences, normative data, location, and time, including, e.g., time of day, day of week and month of year, for the delivery of Just in Time Messages. The present invention implements these collective steps in a way innocuous to the user.

### SUMMARY OF THE INVENTION

The present invention is directed to a method for providing personalized message delivery to a user, comprising: gathering data specific to said user; analyzing said data to determine preferences of said user; determining an order of precedence of said preferences of said user; employing said preferences and said order of precedence to determine personalized message delivery of messages to said user; and providing said personalized message delivery of messages to said user.

The present invention is also directed to a system for providing personalized message delivery to a user, comprising: at least one user interface; a server, wherein said server comprises software, wherein said software gathers data specific to said user, analyzes said data to determine preferences of said user, determines an order of precedence of said preferences of said user, and employs said preferences and said order of precedence to determine personalized message delivery of messages to said user; and a transmitter in communication with said processor and said at least one user interface, wherein said transmitter provides said personalized message delivery of messages to said user through the at least one user interface.

### DESCRIPTION OF THE DRAWINGS

FIG. 1 is a flowchart showing an example of a method and system for providing personalized message delivery that may be used in accordance with the present invention.

FIG. 2 is a schematic that illustrates in more detail steps and the corresponding factors of those steps that may be implemented when using the method and system of the present invention.

FIG. 3 is a schematic that illustrates a general sequence of events that may be followed when using the method and system of the present invention.

FIG. 4 is a schematic that illustrates a server that may be employed when using the method and system of the present invention.

### DETAILED DESCRIPTION OF THE INVENTION

The present invention provides a method and system for effective personalized message delivery by incorporating the user's preferences to prioritize and correlate messages accordingly.

### Definitions

Unless defined otherwise, all technical terms used herein have the same meaning as commonly understood by one of ordinary skill in the art to which the invention belongs. Also, all publications, patent applications, patents, and other references that may be mentioned herein are incorporated by reference.

Geo-Social Data: as used herein Geo-Social Data includes data from the assessment of locations recorded using location-acquisition technologies (e.g., GPS, phone “check in” applications, etc.) that allow generating life patterns, and which associate the user to places he/she frequently visits. Geo-Social Data includes Normative Data that corresponds to a specific location, or to similar locations.

Just in Time Message (“JIT Message”): as used herein JIT Message is a personalized response that may be made in message form, advertisement, reminder, etc., which is conveyed effectively to the user by prioritizing and correlating the message using specific pertinent data prior to the conveyance. As indicated below, Just in Time indicates that the delivery is at the appropriate time, frequency, tone, method and/or mode of delivery for the message content in accordance with User's Preferences (includes both internal and external input).

Network Access Device: as used herein means a device for accessing a communications network capable of transmitting and receiving digital data.

Normative Data: as used herein Normative Data includes data which represents the normal or average response or impact from any given event, (e.g., news, etc.), across various levels, (e.g., age, sex, etc.), used to compare a user's response with an objective external standard.

Now State: as used herein Now State means the best time, frequency, tone, method and/or mode for delivery of the message in accordance to User's Preferences.

Real Time: as used herein means a process, action or transaction that involves updating information without artificial delay, i.e., at the same rate that the information is received.

Present Responsiveness: as used herein Present Responsiveness is a determination of the effectiveness of the message made using data collected from the user in the past, Normative Data and Geo-Social Data to the particular information, mode and method conveyed.

User's Preferences: as used herein User's Preferences are the preferences of a specific user as to the timing, frequency, message tone, method and/or mode of receiving/sharing information.

### EXAMPLES

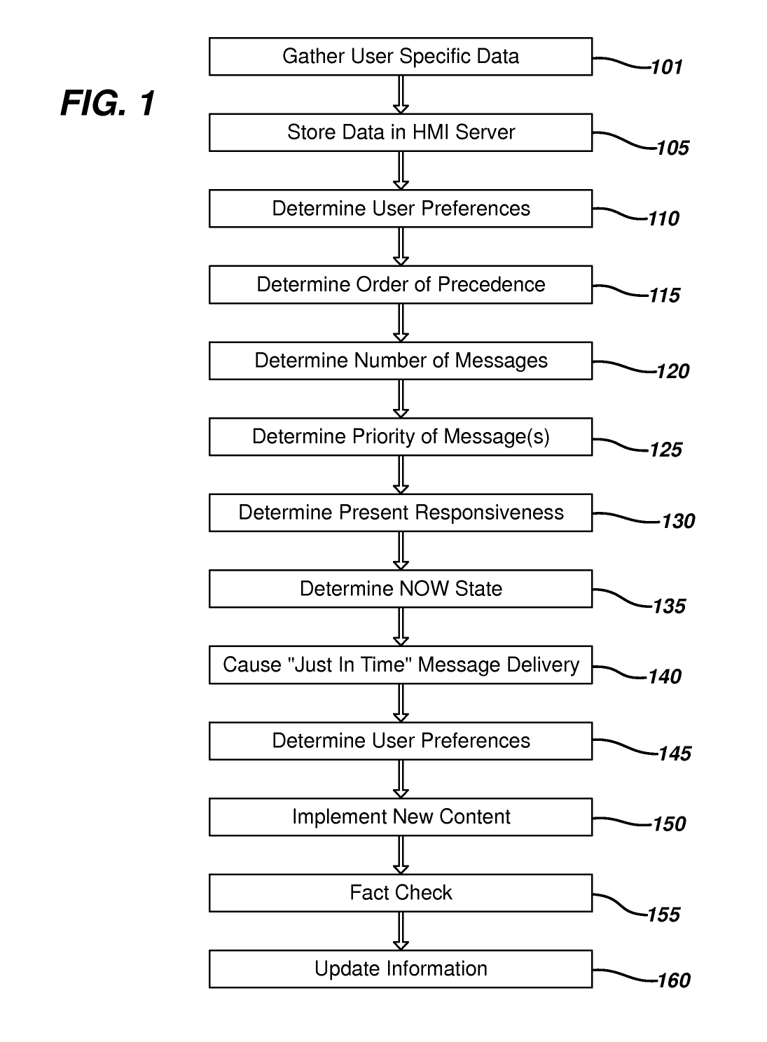

Referring now to FIG. 1, a flowchart that illustrates an example of a method and system for providing personalized message delivery, otherwise referred to herein as JIT Messages, that may be used in accordance with the present invention. Although the method steps are presented in a logical order, the order presented should not be construed to limit the scope of the invention, unless specifically indicated. As explained above, most individuals disregard much of the information conveyed to them. The information is overlooked regardless of the content due to the timing, frequency, tone, method and/or mode in which the messages are conveyed. Gathering data 101 specific to the user from an array of avenues prior to the delivery of the message may bring about appropriate timing, frequency, tone, method, and/or mode of delivery of a particular message. The pertinent data needs to be collected continuously and stored in a server 105 containing software executable to determine User's Preferences and cause the delivery of JIT Messages. The software will be able to analyze information and using the information gathered, determine User's Preferences 110 in relation to specific topics in different areas. After determining the applicable areas, an order of precedence may be determined 115 for the applicable areas. Determining the order of precedence for the messages may allow the software to determine an appropriate number of messages 120 that appear desirable by the user on each area/topic. The determined number of messages can also be prioritized 125 accordingly.

The system will be able to couple the specific message with Present Responsiveness 130 to it. Consequently, effectiveness may be analyzed to determine the best time, i.e., a Now State 135, for delivery of the message in accordance to User's Preferences. This allows the system to cause the delivery of a JIT Message 140. After the JIT Message is conveyed, the user's response or lack of response may be recorded for a second determination of User's Preferences 145. This determination implements the new content 150 if relevant and allows the system to check each response 155. Allowing a check in the responses from the user may further help in the assessment of the effectiveness and perception of the message by the user. Furthermore, checking the response may allow the system to continue to update information 160 and incorporate it for assessment of prospective messages.

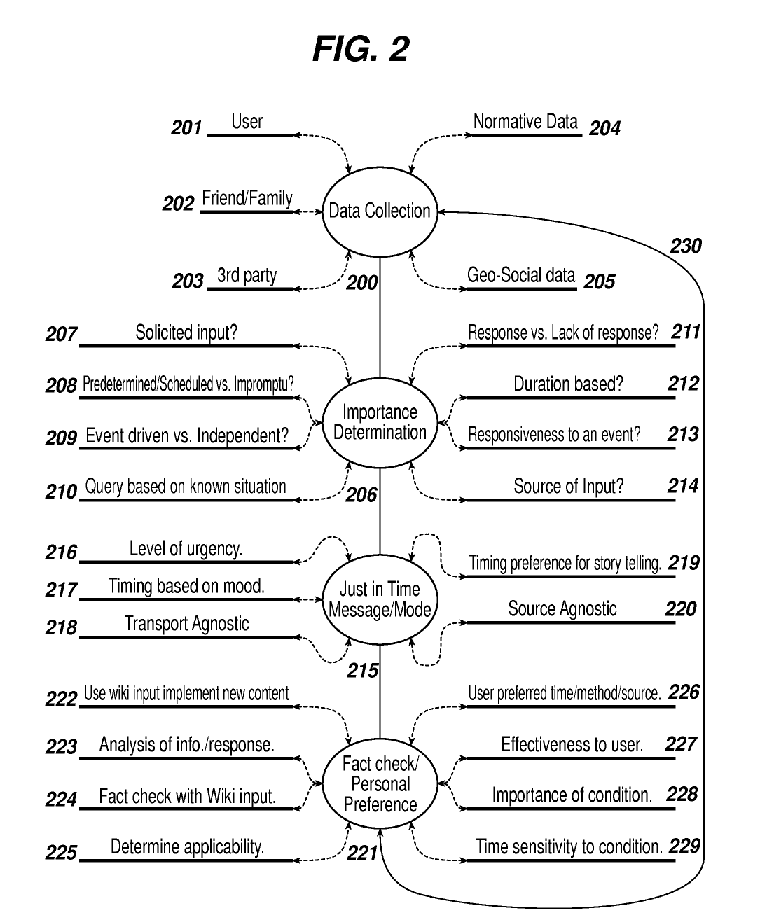

Referring now to FIG. 2, a schematic that illustrates in more detail steps and the corresponding factors of those steps that may be implemented when using the method and system of the present invention. Data collection 200 applicable to the user may include data received from different avenues. The data received may be normalized upon (after?) receipt or alternatively received data may be normalized in a consistent format and in Real Time. The user 201 can supply data to be stored in a server, e.g., the HMI Server, in different ways. User supplied data may include data taken from web/paper questionnaires/consultations, medical devices, wireless devices, PC, etc.

Friends and family 202 may also provide relevant information about the user through different mediums. They may express concerns or provide applicable information about the user through different mediums supported by the system. An example of a medium that would not burden this group and may be implemented by the system would be social networks. These are used every day and can provide useful information in Real Time about the user, without requiring any additional effort.

Third parties 203 may also provide helpful data to the system. Third parties include, e.g., the user's physician, coach, co-worker, manager, etc. These may include data input from the everyday use of mediums supported by the system in ways that do not require any additional action(s). This can provide useful data to the system in many situations. For example, in situations where a change in the individual's activities, preferences, or behavior is noticed by a third party and/or noted in, e.g., a job evaluation, the system can detect the change from the data provided. This allows the system to be of assistance to the user if appropriate and/or convey JIT Messages accordingly.

Normative Data 204 and Geo-Social Data 205 can also help associate responsiveness of messages to particular events or situations. An example of where Normative Data may be useful is when an individual reacts a certain way or becomes interested to an event in the news. This reaction may be categorized, prioritized and correlated to the information in an importance determination.

The importance determination 206 may be made by the system analyzing the data collected. The system may look to see, e.g., if the data input was solicited or unsolicited 207, predetermined/scheduled vs. impromptu 208, event driven vs. independent 209, known vs. unknown situation 210, previous responses vs. lack thereof 211, long vs. short duration 212, consequences to a response or lack thereof 213, and the source of input 214. Essentially these and other possible factors may be applied to an algorithm, which can determine the order of precedence for messages based on multiple inputs and how current something is. The data produced may be used to construct the message “now” or cause the data to be stored and applied in later communications. Additionally, a modification in a predetermined schedule set in a program may be based upon data at T1, T2, T3, etc., up to T now (TN). Another option is to allow some parts of the message to start with the predetermined schedule information followed by new event driven urgent messages.

The JIT response and mode of delivery 215 determination may be made by the system before the messages selected in the importance determination are conveyed. This will help make certain the conveyance is effective and done so in accordance to User's Preferences. The level of urgency 216 and the timing based on mood 217 may be correlated. For example, if data shows a positive response and assimilation of the message by the user when he/she is in a good mood, urgent messages may preferably be delivered during those times. Additionally, it may be determined what time of the day, tone, method and/or mode is best when the individual is in a good mood or bad mood respectively. The user may be more willing to subject himself/herself to storytelling at a specific time 219 during the day.

Finally, the system is able to check facts and updates before the conveyance of the message 221. As a result, an algorithm may, e.g., determine the applicability of credible source data (e.g. Food Pyramid, CDC, benchmarks, WHO, medical and psychological guidelines), and implement new content accordingly 222. The system can cause the message to be delivered in the best-determined method (e.g., wireless device, PC, voicemail, social network post, text message, etc.), source (e.g., local news, survey data, advertisement, event in calendar, etc.) and time. The user's data resulting from the perception or user's analysis and response 223 may be collected and evaluated. Also, facts from the response by the user may be checked using the credible source data (listed above) 224. Moreover, data is also produced by the applicability 225, user's preferred time, method and source 226, effectiveness to the user 227, importance of condition determined 228, and time sensitivity 229 to the message. All this data is collected for updates in the same server 230 for the assessment of subsequent prospective message(s).

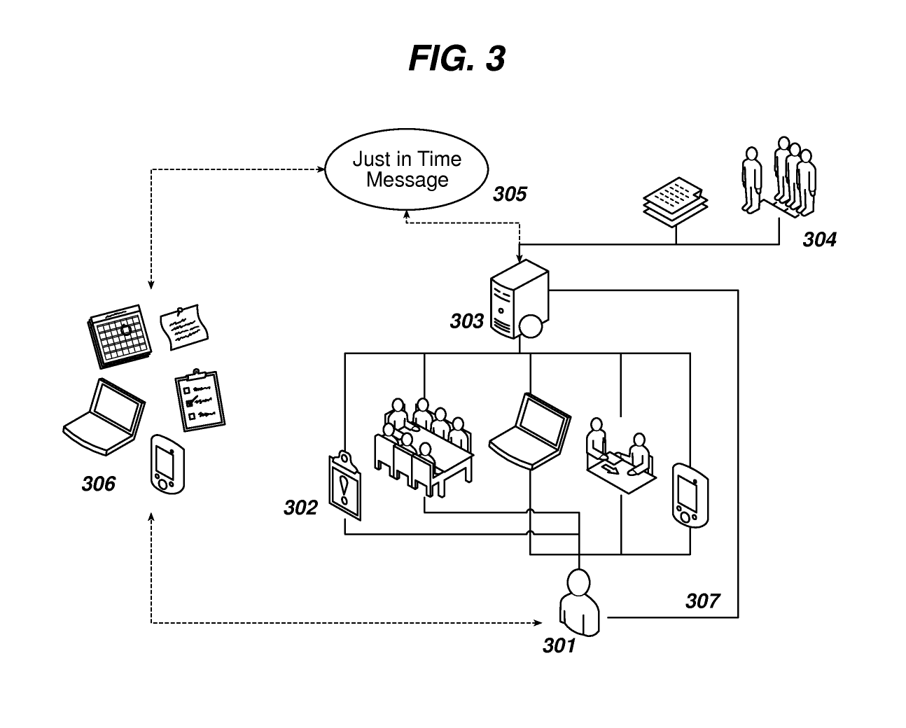

Now referring to FIG. 3, possible sources of data input and storage of data is shown for the determination of Just in Time Messaging as described above. The user 301 of the system directly or indirectly provides data through different avenues, e.g., medical devices, wireless devices, PC, etc., 302. The data is gathered by a server 303, which also collects other information 304 that includes Normative Data and Geo-Social Data as explained above. The server contains software executable to perform the functions described above providing the JIT Message 305. The JIT Message may be conveyed using User's Preferences/most effective means for the message. In addition, data 306 is collected continuously through various devices, e.g., medical devices, wireless devices, PC, etc., to update/increase the precision of JIT Message delivery for future prospective messages.

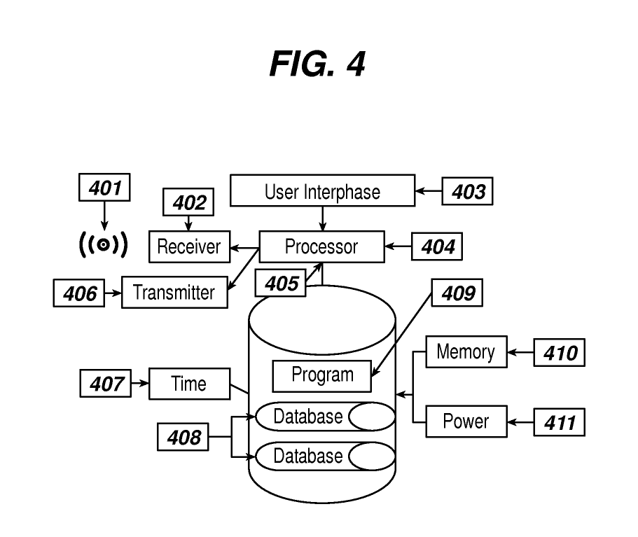

Now referring to FIG. 4, a schematic that illustrates a server that may be employed when using the method and system of the present invention. The server can contain different means of receiving information 401. For example, Bluetooth technology, network/internet capabilities, etc.

A receiver 402 may be used to allow the processor 404/405 to cause the data to be stored in specific databases 408 in uniform format and time. The data can then be used by a program 409 executable to perform the functions as described above. The server also includes a user interface 403 to allow for user interaction and monitoring, a processor for the software 404/405, a means of power 411, memory 410, and a means of keeping Real Time 407 in relation to the specific location of the individual (e.g.,. connecting the user's cell phone to the system to change time accordingly when required due to the user traveling.) A transmitter 406 in logical communication with the processor 404/405 transmits one or more JIT Messages to one or more network access devices associated with the user (not shown) based upon the order of precedence of the user, the NOW state and the priority of messages.

The foregoing examples are not intended to limit the scope of the present invention, which may be set out in the claims. In particular, various equivalents and substitutions will be recognized by those skilled in the art in view of the foregoing disclosure and these are contemplated to be within the scope of the invention.

What is claimed is:

1. A method for providing personalized message delivery to a user, comprising:
gathering data specific to said user;
analyzing said data to determine preferences of said user;
determining an order of precedence of said preferences of said user;
employing said preferences and said order of precedence to determine personalized message delivery of messages to said user; and
providing said personalized message delivery of messages to said user.

2. The method of claim 1, wherein said data is selected from the group consisting of location of said user, time that said user conducts a given activity; response of said user to a given event, request of said user for information regarding a given event.

3. The method of claim 1, wherein said preferences are selected from the group consisting topic, time, frequency, tone, method and mode.

4. The method of claim 1, wherein said personalized message delivery is selected from topic, time of delivery, tone of delivery, frequency of delivery, method of delivery and mode of delivery.

5. The method of claim 1, wherein said personalized message delivery provides messages to said user regarding desired topics.

6. The method of claim 1, wherein said personalized message delivery provides messages to said user at desired times.

7. The method of claim 1, wherein said personalized message delivery provides messages to said user employing desired tones.

8. The method of claim 1, wherein said personalized message delivery provides messages to said user at desired frequency.

9. The method of claim 1, wherein said personalized message delivery provides messages to said user employing desired methods of delivery.

10. The method of claim 1, wherein said personalized message delivery provides messages to said user employing desired modes of delivery.

11. A system for providing personalized message delivery to a user, comprising:
at least one user interface;
a server, wherein said server comprises software, wherein said software gathers data specific to said user, analyzes said data to determine preferences of said user, determines an order of precedence of said preferences of said user, and employs said preferences and said order of precedence to determine personalized message delivery of messages to said user; and
a transmitter in communication with said processor and said at least one user interface, wherein said transmitter provides said personalized message delivery of messages to said user through the at least one user interface.

12. The system of claim 11, wherein the software is operative to receive a timing of one or more events in the user's schedule and to queue a time for one or more transmissions of information to the user based the one or more events in the user's schedule.

13. The system of claim 11, wherein the software is operative to check facts related to the user.

14. The system of claim 13, wherein the software is operative to check the facts via an Internet query.

15. The system of claim 11, wherein the software is operative to determine an order of precedence of user preferences based on a goal set by the user.

16. The system of claim 11, wherein the software is operative to add new content to the messages based upon the preferences of the user.

17. The system of claim 11, wherein the software is operative to transmit to a network access device associated with a third party the messages transmitted to the user.

18. The system of claim 17, wherein the software is operative to transmit to the network access device associated with a third party a reason for transmission of a particular message.

19. The system of claim 17, wherein the system is adapted to be capable of determining a location of said user and to transmit a message to said user based upon said location

20. The system of claim 19, wherein the system capable of automatically determining a location comprises a GPS location device.
